(19) United States
(12) Patent Application Publication
(10) Pub. No.: US 2019/0244247 A1
(43) Pub. Date: Aug. 8, 2019

(54) Counter-Top Billboards

(71) Applicant: Steven McDowell Enterprises, Inc., Novato, CA (US)

(72) Inventors: Gert R. Christen, San Francisco, CA (US); Michael D. London, Novato, CA (US)

(21) Appl. No.: 16/268,131

(22) Filed: Feb. 5, 2019

Related U.S. Application Data
(60) Provisional application No. 62/626,666, filed on Feb. 5, 2018.

(51) Int. Cl. G06Q 30/02

(52) U.S. Cl. CPC G06Q 30/0259; G06Q 30/0276

(57) ABSTRACT

A system and methods related to counter-top billboards are described. A system including a database configured to transmit advertisement to a counter-top billboard.

### CROSS-REFERENCE TO RELATED APPLICATIONS

This application claims priority from U.S. Provisional Patent Application No. 62/626,666, filed on Feb. 5, 2018, which is hereby incorporated by reference in its entireties.

### FIELD

Embodiments of the invention relate to a system including countertop billboards.

### BACKGROUND

New systems and methods for advertising are needed.

### SUMMARY

A system and methods related to counter-top billboards are described. A system including a database configured to transmit advertisement to a counter-top billboard.

Other features and advantages of embodiments will be apparent from the accompanying drawings and from the detailed description that follows.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of a system according to an embodiment;

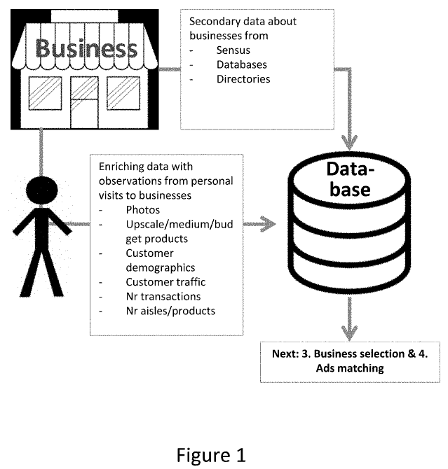

FIG. 2 illustrates a block diagram of a system according to an embodiment;

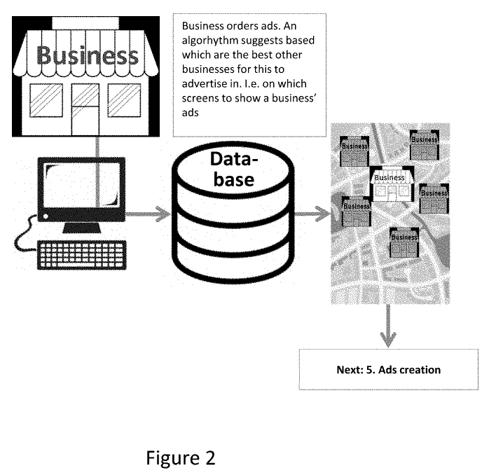

FIG. 3 illustrates a block diagram of a system according to an embodiment;

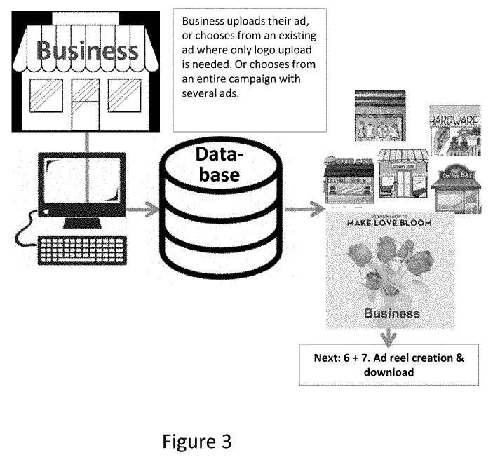

FIG. 4 illustrates a block diagram of a system according to an embodiment;

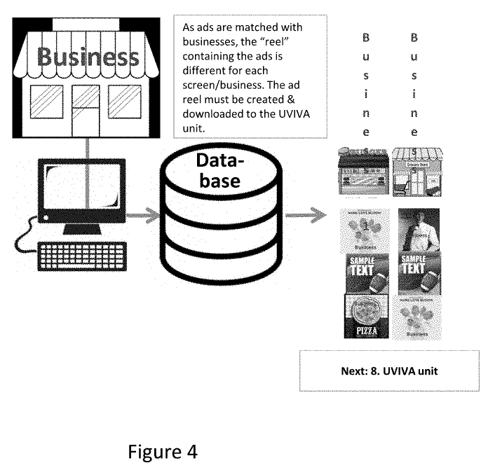

FIG. 5 illustrates a block diagram of a system according to an embodiment; and

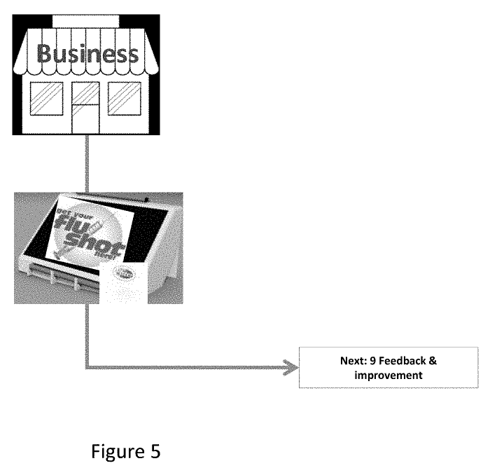

FIG. 6 illustrates a block diagram of a system according to an embodiment.

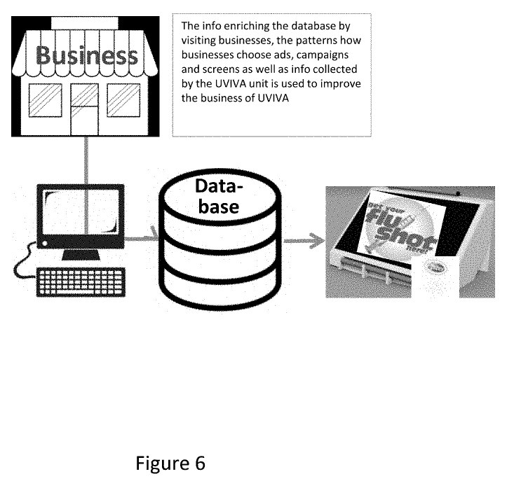

### DETAILED DESCRIPTION

System and methods related to countertop billboards are described herein.

Step 1—Business Data Population

3rd party data acquired to prepopulate a CRM system with data about businesses in communities targeted by UVIVA.

Examples:

Business data from Google, directories

Demographics about area from sensus

Step 2—Business Data Enrichment

A UVIVA sales person visits the businesses in the target area. HE uses the data populated into a database in step 1 to find suitable businesses. He enriches the data about the business thru his own observations, e.g.:

Photos of business inside/outside

Level of cleanliness

Positioning low/mid/premium

Nr of aisles/sales surface/nr products

Demographics of customers (income, age, sex, education, etc)

Estimate of customer traffic

Estimate of number of sales

This is novel because this data can only be captured by physically visiting the business and provides more criteria to classify the business than possible before.

Step 3—Screen Selection

The data base holds information about the business from steps 1+2. It also holds information about many other businesses. Therefore an algorhythm can find those businesses where customers of the business also shop. Example: A flower shop wishing to advertise a Valentine's Day promotion may select to advertise in a bar in the same neighborhood to reach husbands & boyfriends.

Examples of criteria for algorhythm:

Budget=how many other screens can be selected

Customer demographics=where the same customers shop

Income=low/mid/premium, sex, age, products etc. to reach the desired people

Step 4—Matching Businesses with Ads

Based on the information about the business, prepared ads or entire campaigns can be proposed. Again based on the characteristics the database holds about the business. The business can choose to use an existing ad or to join an prepared campaign. Examples:

A sports bar chooses the Superball campaign in January

A dry cleaner chooses an ad about spring cleaning during spring break

This is novel because the prior enriching of the data enables the matching of other businesses and the selection of prepared ads or campaigns. FB & Twitter are similar but not as precise.

Step 5—Creating Ads

Business uses a simple web interface to create the ad they want to show on other screens. The options are:

Upload an existing ad. Must be correct dimensions & resolution

Choose a prepared ad and upload the logo, which must be inserted into the ad

Choose a prepared campaign with several ads & upload the logo, which must be inserted into the ads

This is novel because prepared campaigns in which many businesses participate that are in the same geographic location or who serve the same customers, will create bigger impact because the ads of the campaign are seen over and over again. Each time a little different (logo of different businesses) but the impact is much bigger for all businesses. Competing digital advertising providers do not offer ready made campaigns.

Step 6—Ad Reel Creation

Each business will choose which other businesses it wants its ads to be shown in. This means that each screen in a business will show different ads. Each screen can show up to 20 ads of 6 seconds length. This “movie reel” runs continuously, repeating the ads every 2 minutes. The ads for each screen must be assembled into this movie reel.

Step 7—Ad Reel Download to UVIVA Unit with Screen

At certain intervals each UVIVA unit checks with the UVIVA server whether there is a new reel with ads available. If there is, it downloads it using cellular data 4G/LTE. At the same time it uploads the logfile it has been creating.

Step 8 UVIVA Unit

Sanitizes & dispenses pens

In future can incorporate credit card & mobile payments and other features

Displays the reel with ads & info messages

Polls the server to download new content

Uploads a logfile to the server with contents such as:

Time stamp when each ad was displayed

Time stamp when a person was in front of the unit (motion sensor)

Time stamp a pen was dispenses

Time stamp a pen was returned

etc

What is novel about the UVIVA unit:

Can capture inputs from sensors & make a decision & emit a signal e.g. sound alarm

Can act as a WiFi hotspot or as a smartphone charging station

Can register when a person is in front of unit & which ad was playing at that very moment

Novel: In future can identify person & which product was bought from payment & which ad was playing from unit.

Step 8—Feedback & Improvement

The gathered info serves to determine how to improve the effectiveness of the ads, campaigns, which screens to propose to a business etc.

Some of this is manual, other decisions can be automated thru machine learning.

1. Business Data Population

3rd party data acquired to prepopulate a CRM system with businesses in a target community. Examples:

Sensus demographics

Google/business directory data

2. Business Data Enrichment

Own data from observations e.g. by own sales persons visiting a business & community. To enrich the information in CRM about businesses. This is novel because this data can only be captured by physically visiting the business. Examples:

Photos of business inside/outside

Cleanliness

Products low/mid/premium

Nr of aisles/sales surface

Demographics of customers

Estimate of customer traffic

Estimate of number of sales

3. Ads Creation

A simple tool to design an ad (compare with Vistaprint for biz cards or WIX for websites

A catalog of ready made ads to choose from, e.g. coming with matching flyers to print

Text editor for business to create own info messages, not ads

4. Screen Selection

A tool to choose on which screens ads should be shown (compare FB or Twitter). Examples:

Radius of own customers

Demographics

Budget available Novel because of additional variables only possible thru the combo of Nr. 1 & 2.

5. Ads Matching

An algorhythm matches the ads from 3., based on their criteria from 4. with the best suited & available screens from 1 & 2.

Novel because much more targeted thru 2. & 4.

6. Content Creation & Download

Produces the “reel” of ads to be shown on each unit. Each reel is different because of 5. Novel?

Makes the reel available for the UVIVA Unit to request & download (same way smartphone apps update themselves from a server)

Keeps track of which UVIVA units downloaded the reel, flags the other units for follow up (broken? switched off?, etc. . . . ) Novel?

7. UVIVA Unit

Sanitizes & dispenses pens

In future can incorporate credit card & mobile payments

Displays the reel with ads & info messages

Polls the server 6. to download new content

Novel: Can capture inputs from sensors & make a decision & emit a signal e.g. sound alarm

Novel: Can act as a WiFi hotspot or emit light projections

Novel: Can register when a person is in front of unit & which ad was playing at that very moment

Novel: In future can identify person & which product was bought from payment & which ad was playing from unit.

Now: Sanitizing (pens, stylus')

Now: Dispensing (pens, stylus' etc. . . . )

Future: Credit card payment (mag strip, chip)

Future: Mobile payment (Google Wallet, Apple Pay, Samsung Pay)

Sensors (Now: motion. Future: light, image, noise, smoke, CO2, cannabis, GPS, etc. . . . )

Emitters (Now: Beeper/light. Future: Sound, WiFi, alert, light projection, etc. . . . )

8. Feedback & Improvement

Includes a real-time telco connection to send relevant info from 6. back to server

This info is used by machine learning to improve 4. and 5. and to determine how to better do 1. & 2.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A system comprising:
a database configured to transmit advertisement to a counter-top billboard.

2. A method comprising:
transmitting an advertisement to a counter-top billboard.
